(19) United States
(12) Patent Application Publication
(10) Pub. No.: US 2006/0186646 A1
(43) Pub. Date: Aug. 24, 2006

(54) AIR BAG MODULE COVER WITH LATERAL OPENING AIR BAG DOOR

(75) Inventors: Barney J. BAUER, Shelby Township, MI (US); Jerome BOSCH, Clinton Township, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC., Auburn Hills, MI (US)

(21) Appl. No.: 10/908,775

(22) Filed: May 25, 2005

Related U.S. Application Data
(60) Provisional application No. 60/593,853, filed on Feb. 18, 2005.

(51) Int. Cl. B60R 21/215

(52) U.S. Cl. 280/728.3

(57) ABSTRACT

First and second tear seams separated by a central portion of a panel of an air bag module cover define opposing first and second lateral edges of an air bag door, and are adapted so as to provide for a first region of the first central portion. Upon actuation of the associated air bag inflator, the tear seams fracture allowing the air bag to first deploy laterally, after which the first region of the panel is fractured responsive to relatively higher stresses therein, thereby opening the air bag door. In one embodiment, the tear seams extend along portions of the upper and lower boundaries of the air bag door, and a third tear seam is provided between the portions of the first and second tear seams on one of the upper and lower boundaries, wherein the third tear seam is relatively stronger than the first and second tear seams.

### CROSS-REFERENCE TO RELATED APPLICATIONS

The instant application claims the benefit of prior U.S. Provisional Application Ser. No. 60/593,853 filed on Feb. 18, 2005, which is incorporated herein by reference.

### BRIEF DESCRIPTION OF THE DRAWINGS

FIG. 1 illustrates an air bag module cover installed on air bag inflator module in a vehicle, with an out-of-position occupant located proximate to the air bag inflator module;

FIG. 2 illustrates an early stage of deployment of the air bag inflator illustrated in FIG. 1;

FIG. 3a illustrates a first embodiment of an air bag module cover prior to the activation of an associated air bag inflator;

FIG. 3b illustrates the air bag module cover of FIG. 3a at an early stage of activation of an associated air bag inflator wherein the lateral ends of the associated door commence opening;

FIG. 3c illustrates the air bag module cover of FIG. 3a at a stage of activation of an associated air bag inflator wherein the lower edge of the door separates from the air bag module cover;

FIG. 3d illustrates the air bag module cover of FIG. 3a at a later stage of activation of an associated air bag inflator with the associated door continuing to open;

FIG. 4 illustrates a plan view of the inside surface of a second embodiment of an air bag module cover;

FIG. 5 illustrates a fragmentary first cross section of the second embodiment of the air bag module cover illustrated in FIG. 4;

FIG. 6 illustrates a second cross section of the second embodiment of the air bag module cover illustrated in FIG. 4;

FIG. 7 illustrates a third cross section of the second embodiment of the air bag module cover illustrated in FIG. 4;

FIG. 8 illustrates a plan view of the inside surface of a third embodiment of an air bag module cover;

FIG. 9 illustrates a fragmentary first cross section of the third embodiment of the air bag module cover illustrated in FIG. 8;

FIG. 10 illustrates a second cross section of the third embodiment of the air bag module cover illustrated in FIG. 8;

FIG. 11 illustrates a third cross section of the third embodiment of the air bag module cover illustrated in FIG. 8;

FIG. 12 illustrates a plan view of the inside surface of a fourth embodiment of an air bag module cover;

FIG. 13 illustrates a first cross section of the fourth embodiment of the air bag module cover illustrated in FIG. 12;

FIG. 14 illustrates a second cross section of the fourth embodiment of the air bag module cover illustrated in FIG. 12;

FIG. 15 illustrates a plan view of the inside surface of a fifth embodiment of an air bag module cover;

FIG. 16 illustrates a first cross section of the fifth embodiment of the air bag module cover illustrated in FIG. 15;

FIG. 17 illustrates a plan view of the inside surface of the fifth embodiment of an air bag module cover of FIG. 15 after rupture of associated first and second tear seams but prior to rupture of a central portion of the associated panel; and

FIG. 18 illustrates a plan view of the inside surface of the fifth embodiment of an air bag module cover of FIG. 15 after rupture of the central portion of the associated panel.

### DETAILED DESCRIPTION OF EMBODIMENT(S)

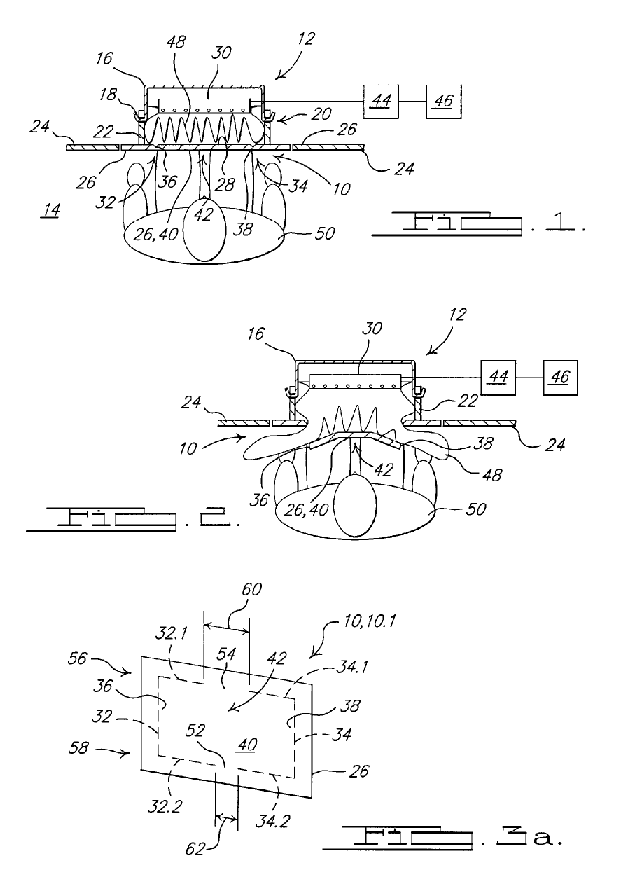

Referring to FIG. 1, an air bag module cover 10 cooperates with an associated air bag air bag inflator module 12 installed in a vehicle 14. For example, the air bag module cover 10 is operatively coupled to a housing 16 of the air bag inflator module 12 by a plurality of hooks 18 that engage a corresponding plurality of slots 20 in an attachment flange 22 that is either part of or operatively coupled to the air bag module cover 10. Alternatively or in addition, the air bag module cover 10 could be operatively coupled to the instrument panel 24 of the vehicle 14. The air bag module cover 10 comprises a panel 26 having an inner side 28 adapted to face towards an air bag inflator 30 of the air bag inflator module 12. The inner side 28 of the panel 26 incorporates first 32 and second 34 tear seams that define corresponding first 36 and second 38 lateral edges of an air bag door 40, wherein the first 36 and second 38 lateral edges are opposite one another, and, for example, as illustrated in FIG. 1, define the left and right edges of the air bag door 40 respectively. The first 32 and second 34 tear seams are separated from one another by a first central portion 42 of the panel 26.

Referring to FIG. 2, the air bag inflator 30 is actuated responsive to a signal from an air bag controller 44, responsive to a crash of the vehicle 14 detected by a crash sensor 46 associated therewith. Upon actuation, the air bag inflator 30 generates a gas that fills an air bag 48 packed within the air bag inflator module 12, thereby pressurizing the air bag 48 against the panel 26 of the air bag module cover 10 so as to generate mechanical stresses therein, which cause the first 32 and second 34 tear seams defining the first 36 and second 38 lateral edges of the air bag door 40 to fracture. The pressurization of the air bag 48 acting on the air bag door 40 causes the first 36 and second 38 lateral edges thereof to open first, thereby enabling the air bag 48 to deploy therethrough, thereby providing for an initial lateral deployment of the air bag 48 from the air bag inflator module 12. The relatively stronger first central portion 42 of the panel 26 initially remains in tact, thereby preventing the air bag 48 from deploying directly at an out-of-position (OOP) occupant 50, which otherwise could be hazardous to the out-of-position (OOP) occupant 50, particularly children. For example, some air bag mounting configurations, particularly the conventional mid-mount air bag installation, place the air bag door 40 almost directly in front of the chest of the 3 year old and the 6 year old dummy in the NHTSA-I position (chest adjacent to panel), for which an air bag 48 otherwise deploying from the front center of the air bag inflator module 12 could cause the associated chest impact pressure of the out-of-position (OOP) occupant 50 to exceed the Federal Standard at relatively early stages of deployment (e.g. during the first 3 to 5 milliseconds) as the air bag door 40 begins to open.

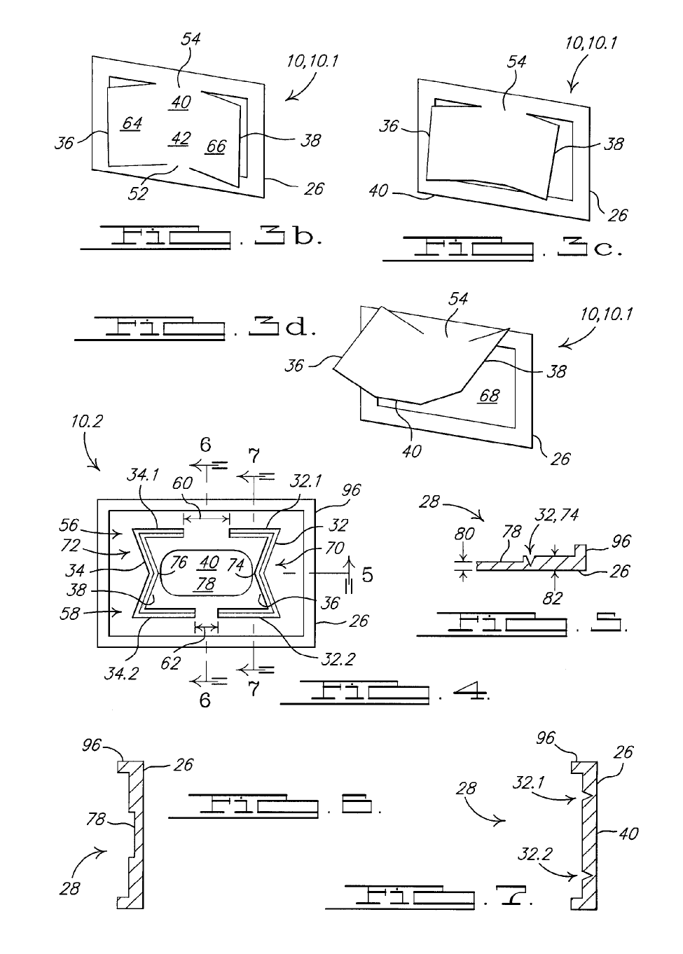

Referring to FIG. 3a, in accordance with a first embodiment of an air bag module cover 10.1, the first 32 and second 34 tear seams are adapted so as to provide for a first 52 and second 54 regions of the first central portion 42 of the panel 26, wherein upon actuation of the air bag inflator module 12, the first region 52 is subjected to higher stress than the second region so as to provide for fracturing the panel 26 in the first region 52 following a fracture of the first 32 and second 34 tear seams, and the second region 54 provides for hinging the air bag door 40 from said panel 26. For example, a first portion 32.1 of the first tear seam 32 extends from the first lateral edge 36 along a portion of an upper boundary 56 of the air bag door 40, a second portion 32.2 of the first tear seam 32 extends from the first lateral edge 36 along a portion of a lower boundary 58 of the air bag door 40, a first portion 34.1 of the second tear seam 34 extends from the second lateral edge 38 along a portion of the upper boundary 56, and a second portion 34.2 of the second tear seam 34 extends from the second lateral edge 38 along a portion of the lower boundary 58 of the air bag door 40. For an air bag door 40 hinged along the upper boundary 56 thereof, a first length 60 of the first central portion 42 between the respective first portions 32.1, 34.1 of the first 32 and second 34 tear seams is longer than a second length 62 of the first central portion 42 between the second portions 32.2, 34.1 of the first 32 and second 34 tear seams, so that upon inflation of the air bag 48, after the first 32 and second 34 tear seams are first ruptured responsive to the pressure of the air bag 48—thereby deflecting the first 64 and second 66 lateral portions of the air bag door 40 so as to enable the air bag 48 to be initially deployed therethrough, as illustrated in FIGS. 2 and 3b —the first region 52 of the first central portion 42 is stressed higher than the second region 54 so as to cause the first region 52 to rupture responsive to the pressure of the air bag 48, as illustrated in FIG. 3c, after which the air bag door 40 to continues to open as illustrated in FIG. 3d, thereby enabling the air bag 48 to deploy through the air bag door opening 68 of the air bag module cover 10. For an air bag door 40 hinged along the lower boundary 58 thereof, the first length 60 would be shorter than the second length 62, and the first 52 and second 54 regions of the first central portion 42 would be reversed.

Accordingly, the air bag module cover 10 provides for an initial lateral deployment of the air bag 48, i.e. rightwards and leftwards of the chest, i.e. towards either side of the chest, so as to provide for moving the out-of-position (OOP) occupant 50 away from the air bag door 40 before the first central portion 42 of the air bag door 40 begins to open, which provides for lower overall contact pressures on each side of the chest, which also provides for avoiding the high center of chest loading that can otherwise be injurious to an out-of-position (OOP) occupant 50.

Referring to FIGS. 4-7, in accordance with a second embodiment of an air bag module cover 10.2, a first path 70 of the first tear seam 32 along the first lateral edge 36 and a second path 72 the second tear seam 34 along the second lateral edge 38 each comprise a corresponding first 74 and second 76 vertex, wherein, the first 74 and second 76 vertexes are each oriented pointing towards the air bag door 40 so as to form associated stress risers that provide for initiating rupture of the associated first 32 and second 34 tear seams responsive to a pressurization of the air bag 48. In accordance with a second aspect, the panel 26 comprises a second central portion 78 spanning a substantial portion of the panel 26 within a region bounded by the first 32 and second 34 tear seams and within the upper 56 and lower 58 boundaries of the air bag door 40, wherein the thickness 80 of the second central portion 78 is less than the thickness 82 of a remaining portion of the panel 26. The second central portion 78 acts in cooperation with the first 32 and second 34 tear seams and the first 74 and second 76 vertexes so as to create associated stress risers that facilitate the rupture of the first 32 and second 34 tear seams responsive to a pressurization of the air bag 48.

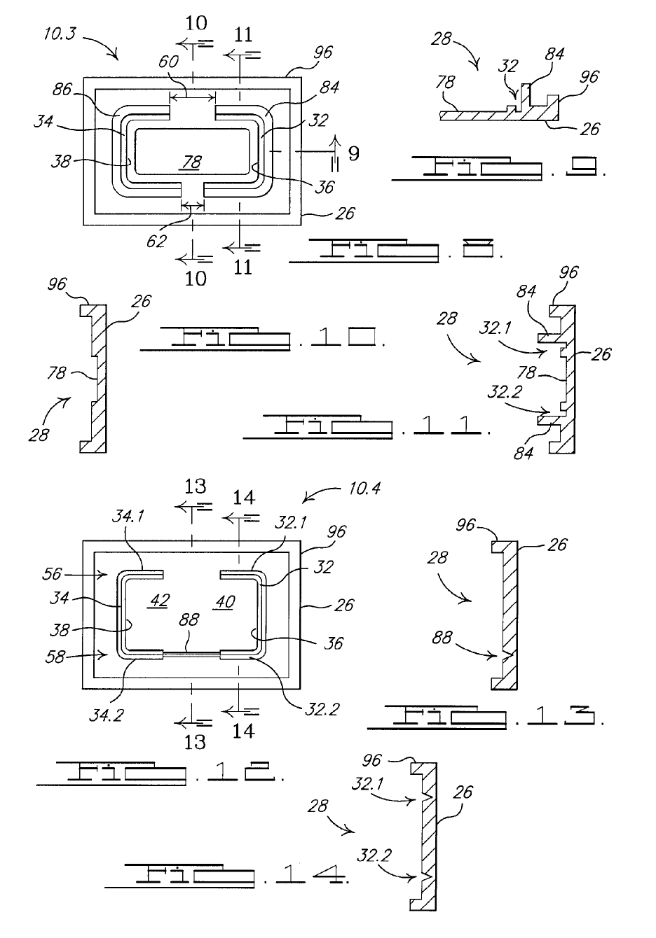

Referring to FIG. 8-11, in accordance with a third embodiment of an air bag module cover 10.3, the inner side 28 of the panel 26 incorporates first 84 and second 86 ribs at least partially surrounding a boundary 32, 34, 56, 58 of the air bag door 40, so as to stiffen a portion of the panel 26 outside and proximate to the first 32 or second 34 tear seams, so as to provide for facilitating the rupture of the first 32 and second 34 tear seams responsive to a pressurization of the air bag 48. The layout of the first 32 and second 34 tear seams is otherwise similar to that of the first embodiment of an air bag module cover 10.1, as described hereinabove with reference to FIG. 3a. In accordance with the second aspect, the third embodiment of an air bag module cover 10.3 also incorporates a second central portion 78 that functions similar in principle to that of the second embodiment of an air bag module cover 10.2, as described hereinabove with reference to FIGS. 4-7.

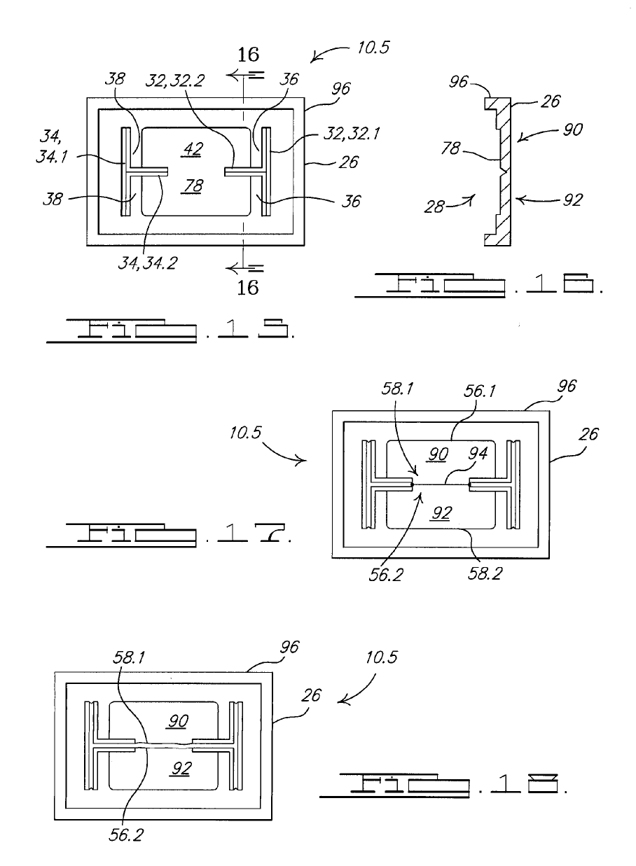

Referring to FIGS. 12-14, in accordance with a fourth embodiment of an air bag module cover 10.4, the inner side 28 of the panel 26 incorporates first 32 and second 34 tear seams that define corresponding first 36 and second 38 lateral edges of an air bag door 40, wherein the first 36 and second 38 lateral edges are opposite one another, and, for example as illustrated in FIG. 12, define the left and right edges of the air bag door 40 respectively. The first 32 and second 34 tear seams are separated from one another by a first central portion 42 of the panel 26. A first portion 32.1 of the first tear seam 32 extends from the first lateral edge 36 along a portion of an upper boundary 56 of the air bag door 40, a second portion 32.2 of the first tear seam 32 extends from the first lateral edge 36 along a portion of a lower boundary 58 of the air bag door 40, a first portion 34.1 of the second tear seam 34 extends from the second lateral edge 38 along a portion of the upper boundary 56, and a second portion 34.2 of the second tear seam 34 extends from the second lateral edge 38 along a portion of the lower boundary 58 of the air bag door 40. For an air bag door 40 hinged along the upper boundary 56 thereof, the inner side 28 of the panel 26 incorporates a third tear seam 88 operative on the lower boundary 58 of the air bag door 48 between second portions 32.2, 34.2 of the first 32 and second 34 tear seams, wherein the third tear seam 88 is relatively stronger than either the first tear seam 32 of the second tear seam 34, so that the third tear seam 88 ruptures after the first 32 and second 34 tear seams responsive to a pressurization of the air bag 48.

Referring to FIG. 15-18, in accordance with a fifth embodiment of an air bag module cover 10.5, the panel 26 comprises first 90 and second 92 air bag doors. First portions 32.1, 34.1 of first 32 and second 34 tear seams bound corresponding first 36 and second 38 lateral edges of the first 90 and second 92 air bag doors. Second portions 32.2, 34.2 of the first 32 and second 34 tear seams extend inward from the corresponding first portions 32.1, 34.1, and the second portions 32.2, 34.2 of the first 32 and second 34 tear seams, together with a path 94 therebetween through the associated first central portion 42 of the panel 26, form the lower boundary 58.1 of the first air bag door 90 and the upper boundary 56.2 of the second air bag door 92. Accordingly, the first air bag door 90 hinges along its upper boundary 56.1, and the second air bag door 92 hinges along its lower boundary 58.2. Upon pressurization of the air bag 40, first 32 and second 34 tear seams rupture first, increasing the relative stress within the first central portion 42 of the panel 26 across the path 94 until the first central portion 42 of the panel 26 fractures along the path 94. In accordance with the second aspect, the fifth embodiment of an air bag module cover 10.5 also incorporates a second central portion 78 that functions similar in principle to that of the second embodiment of an air bag module cover 10.2, as described hereinabove with reference to FIGS. 4-7.

Referring to FIGS. 4-18, the air bag module cover 10 may incorporate a rim 96 along the periphery of the associated panel 26 so as to provide for stiffening the panel 26. The air bag module cover 10 is, for example, constructed of a molded plastic, foam or composite material.

The first 32 and second 34 tear seams may, for example, be either molded into the air bag module cover 10, or may be provided by other means, for example, laser or machine cutting operations. Furthermore, the first 32 and second 34 tear seams may either be continuous or segmented.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

What is claimed is:

1. An air bag module cover, comprising:
a. a panel adapted to cooperate with an air bag inflator module, wherein said panel has an inner side adapted to face towards an air bag inflator of said air bag inflator module;
b. at least one first tear seam defining at least a portion of a first lateral edge of at least one air bag door in said panel; and
c. at least one second tear seam defining at least a portion of a second lateral edge of said at least one air bag door in said panel, wherein said first and second lateral edges are opposite to one another, said first and second tear seams are separated from one another by a first central portion of said panel, said first and second tear seams are adapted so as to provide for a first region and at least one second region of said first central portion of said panel, wherein upon actuation of said air bag inflator module said first region is subjected to relatively higher stress than said at least one second region and said first region is subjected to relatively lower stress than either said at least one first tear seam or said at least one second tear seam, so as to provide for fracturing said panel in said first region following a fracture of said at least one first tear seam and said at least one second tear seam, wherein said at least one second region provides for hinging said at least one air bag door from said panel.

2. An air bag module cover as recited in claim 1, wherein a first portion of said at least one first tear seam extends from said first lateral edge along a portion of an upper boundary of said at least one air bag door, a second portion of said at least one first tear seam extends from said first lateral edge along a portion of a lower boundary of said at least one air bag door, a first portion of said at least one second tear seam extends from said second lateral edge along a portion of said upper boundary of said at least one air bag door, and a second portion of said at least one second tear seam extends from said second lateral edge along a portion of said lower boundary of said at least one air bag door.

3. An air bag module cover as recited in claim 2, wherein a first length of said first central portion between said first portions of said at least one first tear seam and said at least one second tear seam is different from a second length of said first central portion between said second portions of said at least one first tear seam and said at least one second tear seam.

4. An air bag module cover as recited in claim 1, wherein said panel comprises a second central portion within a region bounded by said at least one first tear seam and said at least one second tear seam, said second central portion is below an upper boundary of said at least one air bag door, said second central portion is above a lower boundary of said at least one air bag door, a thickness of said second central portion is less than a thickness of a remaining portion of said panel, and said second central portion spans a substantial portion of said panel.

5. An air bag module cover as recited in claim 1, wherein said at least one air bag door comprises a single air bag door that hinges along either said upper boundary or said lower boundary.

6. An air bag module cover as recited in claim 1, wherein said at least one air bag door comprises a first air bag door and a second air bag door, said first air bag door hinges along an upper boundary thereof in a first of said at least one second region of said first central portion of said panel, said second air bag door hinges along a lower boundary thereof in a second of said at least one second region of said first central portion of said panel, and said first and second air bag doors are separated along a path within said first central portion of said panel between said at least one first tear seam and said at least one second tear seam.

7. An air bag module cover as recited in claim 1, wherein at least one of a first path of said at least one first tear seam along said first lateral edge and a second path of said at least one second tear seam along said second lateral edge comprise at least one vertex.

8. An air bag module cover as recited in claim 7, wherein a first path of said at least of said at least one first tear seam along said first lateral edge comprises at least one first vertex, and a second path said at least one second tear seam along said second lateral edge comprises at least one second vertex.

9. An air bag module cover as recited in claim 1, wherein said at least one first tear seam and said at least one second tear seam are formed on said inner side of said panel.

10. An air bag module cover as recited in claim 1, wherein said panel comprises at least one rib on said inner side at least partially surrounding a boundary of said at least one air bag door.

11. An air bag module cover, comprising:
a. a panel adapted to cooperate with an air bag inflator module, wherein said panel has an inner side adapted to face towards an air bag inflator of said air bag inflator module;
b. at least one first tear seam defining at least a portion of a first lateral edge of at least one air bag door in said panel wherein a first portion of said at least one first tear seam extends from said first lateral edge along a portion of an upper boundary of said at least one air bag door, a second portion of said at least one first tear seam extends from said first lateral edge along a portion of a lower boundary of said at least one air bag door;
c. at least one second tear seam defining at least a portion of a second lateral edge of said at least one air bag door in said panel, wherein a first portion of said at least one second tear seam extends from said second lateral edge along a portion of said upper boundary of said at least one air bag door, a second portion of said at least one second tear seam extends from said second lateral edge along a portion of said lower boundary of said at least one air bag door, and said first and second lateral edges are opposite to one another; and
d. at least one third tear seam operative between said at least one first tear seam and said at least one second tear seam on one of said upper boundary or said lower boundary of said at least one air bag door, wherein said at least one third tear seam is relatively stronger than either said at least one first tear seam or said at least one second tear seam.

12. An air bag module cover as recited in claim 11, wherein said at least one first tear seam, said at least one second tear seam, and said at least one third tear seam are formed on said inner side of said panel.

13. A method of providing for an air bag door in an air bag module cover, comprising:
a. providing first and second lateral tear seams bounding at least one door in a panel of the air bag module, wherein said first and second lateral tear seams are distal to a central portion of said panel, and said first and second lateral tear seams extend along at least one of a portion of a top edge of said at least one door and a portion of said bottom edge of said at least one door;
b. providing for tearing said first and second lateral tear seams before tearing said central portion of said panel responsive to an actuation of an air bag inflator of said air bag module;
c. providing for adapting said first and second lateral tear seams along said at least one of said portion of said top edge of at least one door and said portion of said bottom edge of said at least one door so as to define first and at least one second regions of said central portion, wherein said first region is subject to a relatively higher stress than said at least one second region responsive to said actuation of said air bag inflator;
d. providing for tearing said panel along said first region after said panel is torn along said first and second lateral tear seams; and
e. providing for hinging said at least one door about at least one hinge portion in said at least one second region.

14. A method of providing for an air bag door in an air bag module cover as recited in claim 13, wherein said first and second lateral tear seams extend along a portion of a top edge of at least one door and along a portion of said bottom edge of said at least one door.

15. A method of providing for an air bag door in an air bag module cover as recited in claim 14, further comprising providing for a central tear seam within said first region of said central portion, wherein said central tear seam is stronger than said first and second lateral tear seams.

16. A method of providing for an air bag door in an air bag module cover as recited in claim 13, further comprising adapting said central portion so as to provide for at least one stress riser along at least one of said first lateral tear seam and said second lateral tear seam. A method of providing for an air bag door in an air bag module cover as recited in claim 16, wherein the operation of adapting said central portion so as to provide for at least one stress riser comprises reducing a thickness of said panel in substantial portion of said at least one door bounded by said first and second tear seams.

17. A method of providing for an air bag door in an air bag module cover as recited in claim 13, further comprising shaping at least one path of at least one of said first and second lateral tear seams so as to form a stress riser therein.

18. A method of providing for an air bag door in an air bag module cover as recited in claim 18, wherein the operation of shaping said at least one path of at least one of said first and second lateral tear seams so as to form a stress riser therein comprises forming at least one vertex in said at least one path of at least one of said first and second lateral tear seams.

19. A method of providing for an air bag door in an air bag module cover as recited in claim 19, wherein said at least one vertex is located along at least one lateral edge of at least one door and is adapted to point towards said at least one door.

20. A method of providing for an air bag door in an air bag module cover as recited in claim 13, further comprising adapting at least a portion of the air bag module cover outside said at least one door so as to provide for at least one stress riser along at least one of said first lateral tear seam and said second lateral tear seam.

21. A method of providing for an air bag door in an air bag module cover as recited in claim 21, wherein the operation of adapting at least a portion of the air bag module cover outside said at least one door so as to provide for at least one stress riser along at least one of said first lateral tear seam an said second lateral tear seam comprises stiffening said panel in a region proximate to at least one of said first and second lateral tear seams.

22. A method of providing for an air bag door in an air bag module cover as recited in claim 22, wherein the operation of stiffening said panel in a region proximate to at least one of said first and second lateral tear seams comprises forming at least one rib on said panel adjacent to at least one of said first and second lateral tear seams.
